(19) United States
(12) Patent Application Publication
(10) Pub. No.: US 2004/0019644 A1
(43) Pub. Date: Jan. 29, 2004

(54) Dissemination control of email text

(75) Inventors: Craig Fellenstein, Brookfield, CT (US); Carl Phillip Gusler, Austin, TX (US); Rick Allen Hamilton II, Charlottesville, VA (US); James Wesley Seaman, Falls Church, VA (US)

Correspondence Address: Robert V. Wilder, 4235 Kingsburg Drive, Round Rock, TX, 78681, US

(73) Assignee: International Business Machines Corporation, Armonk, NY

(21) Appl. No.: 10/202,723

(22) Filed: Jul. 25, 2002

(51) Int. Cl. G06F 15/16; G09G 5/00

(52) U.S. Cl. 709/206; 345/752

(57) ABSTRACT

A method and implementing computer system are provided in which a senders of electronic communications such as email are enabled to selectively control the sending and display of portions of electronic communications. In one example, selected portions of a message may be viewed by only selected recipients and other sections of the communications may be viewed by all recipients. In another exemplary embodiment, means are also provided to select print disable and forwarding disable functions, which when selected, are effective to prevent printing or forwarding, respectively, of all or selected portions of a received message by selected recipients.

### FIELD OF THE INVENTION

The present invention relates generally to information processing systems and more particularly to a methodology and implementation for enabling text management in electronic communication systems.

### BACKGROUND OF THE INVENTION

Email has become an indispensable tool in today's business environment. The flexibility of email systems, therefore, directly affects the productivity of email users, and thus, business itself. Often, an email message will contain a majority of data which is usable and necessary to a wide audience, however, the same email message may contain data which is not suitable or appropriate for one or more recipients on the mail list. Current electronic communication systems do not provide any means for managing and controlling text in electronic messages relative to addressees or recipients identified on distribution recipients list for the communication.

Thus, there is a need for an improved methodology and system for enabling the control and management of text within electronic messages.

### SUMMARY OF THE INVENTION

A method and implementing computer system are provided in which senders of electronic communications such as email are enabled to selectively control the sending and display of portions of electronic communications. In one example, selected portions of a message may be viewed by only selected recipients and other sections of the communications may be viewed by all recipients. In another exemplary embodiment, means are also provided to select print disable and forwarding disable functions, which when selected, are effective to prevent printing or forwarding, respectively, of all or selected portions of a received message by selected recipients.

### BRIEF DESCRIPTION OF THE DRAWINGS

A better understanding of the present invention can be obtained when the following detailed description of a preferred embodiment is considered in conjunction with the following drawings, in which:

FIG. 1 is a computer system which may be used in an exemplary implementation of the present invention;

FIG. 2 is a schematic block diagram illustrating several of the major components of an exemplary computer system;

FIG. 3 is an illustration of an email screen or display which may be used in an exemplary embodiment of the present invention;

FIG. 4 is a further illustration of an exemplary implementation of the present invention;

FIG. 5 is an exemplary display screen illustration showing several selectable control features of the present invention;

FIG. 6 is another exemplary display screen illustration showing several additional selectable control features of the present invention;

FIG. 7 is an exemplary email used in explaining the operation of an exemplary embodiment of the present invention;

FIG. 8 is another email illustration used in explaining an operation of the present invention;

FIG. 9 is a flow chart illustrating an exemplary flow or operational sequence of an exemplary embodiment of the present invention; and

FIG. 10 is a continuation of the flow chart illustrated in the FIG. 9 example.

### DETAILED DESCRIPTION

It is noted that circuits and devices which are shown in block form in the drawings are generally known to those skilled in the art, and are not specified to any greater extent than that considered necessary as illustrated, for the understanding and appreciation of the underlying concepts of the present invention and in order not to obfuscate or distract from the teachings of the present invention.

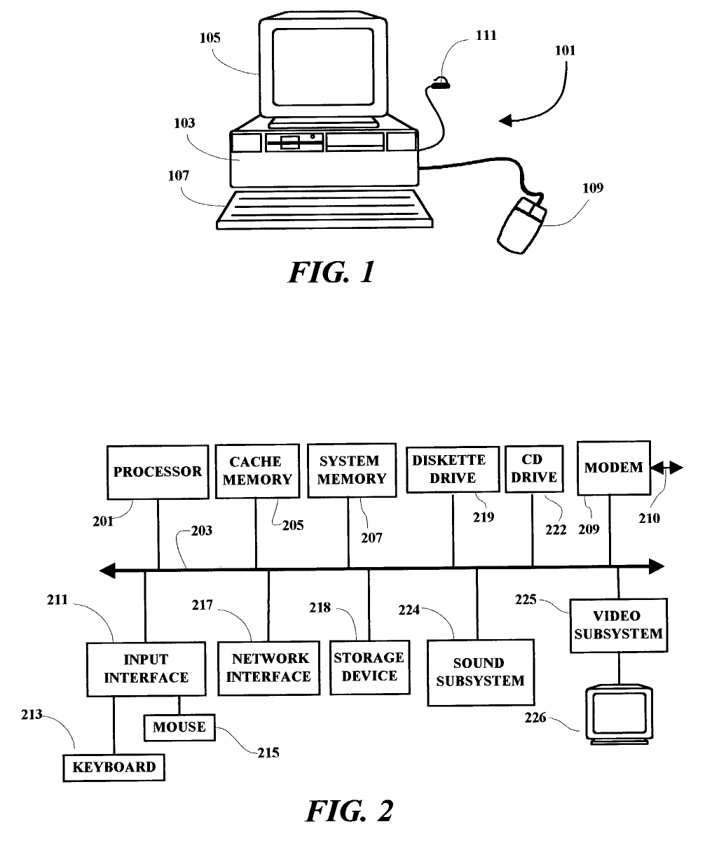

With reference to FIG. 1, the various methods discussed herein may be implemented within a computer network including a computer terminal 101, which may comprise either a workstation, personal computer (PC), laptop computer or a wireless computer system. In general, an implementing computer system may include any computer system and may be implemented with one or several processors in a wireless system or a hard-wired multi-bus system in a network of similar systems.

In FIG. 1, the computer system includes a processor unit 103 which is typically arranged for housing a processor circuit along with other component devices and subsystems of a computer terminal 101. The computer terminal 101 also includes a monitor unit 105, a keyboard 107 and a mouse or pointing device 109, which are all interconnected with the computer terminal illustrated. Also shown is a connector 111 which is arranged for connecting a modem within the computer terminal to a communication line such as a telephone line in the present example. The present invention may also be implemented in a cellular system as noted above.

Several of the major components of the terminal 101 are illustrated in FIG. 2. A processor circuit 201 is connected to a system bus 203 which may be any host system bus. It is noted that the processing methodology disclosed herein will apply to many different bus and/or network configurations. A cache memory device 205 and a system memory unit 207 are also connected to the bus 203. A modem 209 is arranged for connection 210 to a communication line, such as a telephone line, through a connector 111 (FIG. 1). The modem 209, in the present example, selectively enables the computer terminal 101 to establish a communication link and initiate communication with network and/or email server through a network connection such as the Internet.

The system bus 203 is also connected through an input interface circuit 211 to a keyboard 213 and a mouse or pointing device 215. The bus 203 may also be coupled through a hard-wired network interface subsystem 217 which may, in turn, be coupled through a wireless or hard-wired connection to a network of servers and mail servers on the world wide web. A diskette drive unit 219 and a CD drive unit 222 are also shown as being coupled to the bus 203. A video subsystem 225, which may include a graphics subsystem, is connected to a display device 226. A storage device 218, which may comprise a hard drive unit, is also coupled to the bus 203. The diskette drive unit 219 as well as the CD drive 222 provide a means by which individual diskette or CD programs may be loaded into memory or on to the hard drive, for selective execution by the computer terminal 101. As is well known, program diskettes and CDs containing application programs represented by magnetic indicia on the diskette or optical indicia on a CD, may be read from the diskette or CD drive, and the computer system is selectively operable to read such magnetic or optical indicia and create program signals. Such program signals are selectively effective to cause the computer system to present displays on the screen of a display device and respond to user inputs in accordance with the functional flow of the application program.

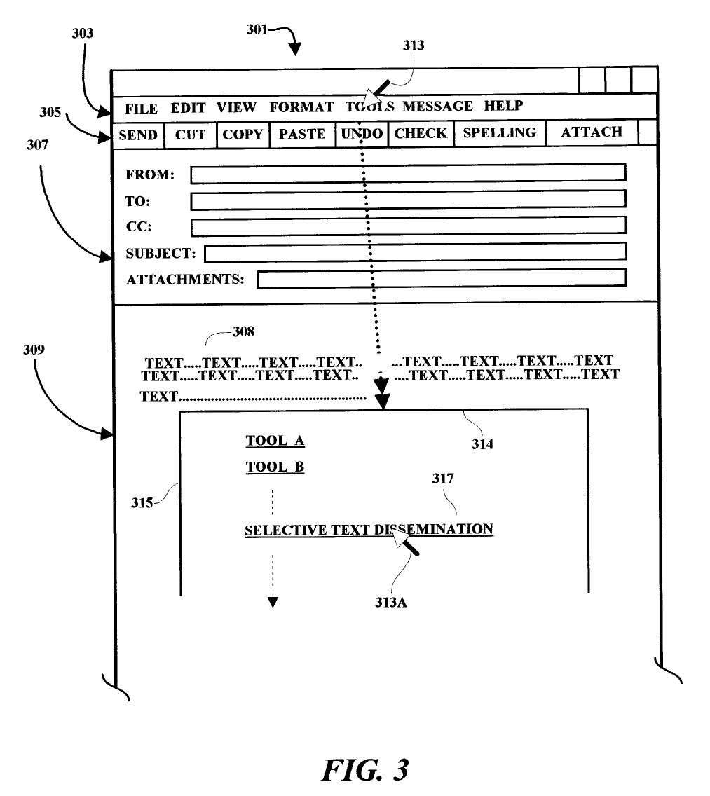

FIG. 3 illustrates an email application program in which the present invention is implemented in the disclosed exemplary embodiment. As described below, the present invention enables senders of electronic communications such as email to selectively control the sending, display, forwarding and/or printing, inter alia, of portions of electronic communications such that selected portions of a message may be viewed by only selected recipients and other sections of the communications may be viewed by all recipients. In the disclosed example, the home screen 301 of the email program includes several menu bars 303 and 305 which indicate various functions and tools usable in connection with the email operation. The next screen section 307 is an email heading section which includes the sender identification, the identification of the parties addressed to receive the communication including those who receive copies, the subject of the communication and a listing of any attachments to the email. The next section 309 contains the body of the email communication and is shown as containing the “text” 308 of a communication being sent from the sender to one or more receivers or addressees of the email.

Although the present invention is illustrated as being implemented within an email program, it is understood that the methodology disclosed herein may also be implemented as stand-alone code which may run independently of the email program. As illustrated in the disclosed example, the present invention is implemented such that it is called from the “TOOLS” selection of the email menu 303 by pointing to the “TOOLS” item with a displayed pointer 313 and clicking or actuating a button switch on an associated mouse device. As shown, that action will cause a pop-up window 314 to appear over the text of the email message showing the tools that are available to the user in connection with the email communication underlying the window 314.

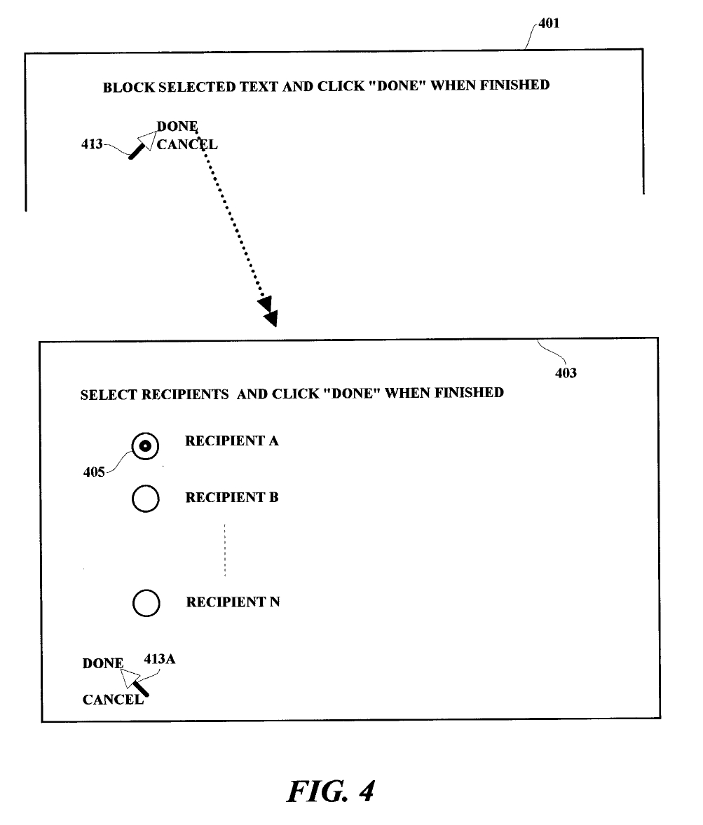

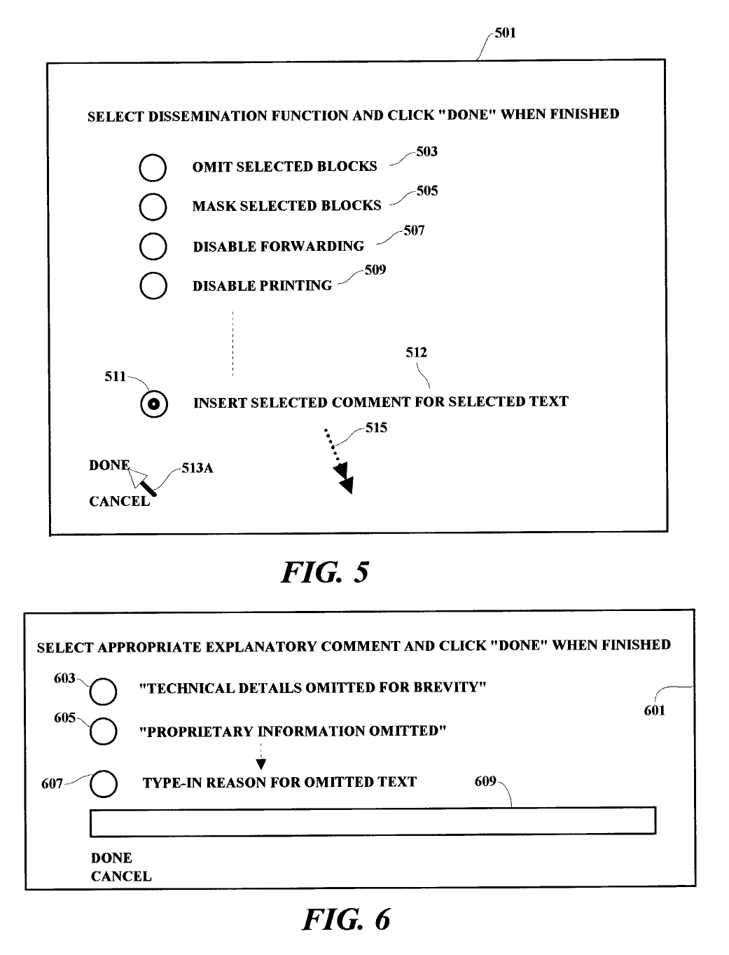

As shown in FIG. 4, the next pop-up window 401 provides a screen which is used to instruct the user to block or highlight the text in the message which the user wishes to manage or control in a selected manner. At this point, the user will highlight the selected portions of the underlying email message and click on the “DONE” selection to indicate that the user's selection has been completed. It is noted that throughout the disclosed example, a user may “CANCEL” the text control function at any point and return to the email base page shown in FIG. 3. When a user uses the pointer 413 and clicks 413 on the “DONE” selection, another pop-up window 403 is presented which enable the user to select the recipients whose email will include the changes to be made by the user. It is noted here that the user may select one or more recipients and only the emails of those selected will include the changes to be made by the user. In the preferred embodiment, when the user has finished the selection of affected blocks of text by highlighting in some predetermined manner such as emboldening and/or underscoring the selected text segments, the program will fetch and list the addressees listed on the email and present those names on screen 403. The user is then enabled to select from the listed names, only those names whose emails are to be modified by the user. It is noted here that the user may go through this iteration several times in order to select several groups of addressees who will have the indicated changes made to only their emails. After the user has selected the target recipients, foe example by clicking in the circle 405 next to an identified name, the user may click on the “DONE” indicium using the pointer 413A and the next screen 501 as shown in FIG. 5 will be presented to the user.

As shown in FIG. 5, after the user has selected the target text and the target addressees, a dissemination function selection screen 501 is presented which enable the user to select what type of dissemination is to be implemented with regard to the selected text and the selected addressees. The example illustrated shows several selections by which a user may select to omit 503 the selected blocks of text for the selected addressees, or to mask 505 in a predetermined manner the selected text for the selected addressees. Further examples of text control functions include user selections by which, for the selected text and the selected addressees, the forwarding function 507 and/or the ability to print 509 the selected text may be disabled. These selections will prevent a recipient from forwarding the selected text (and/or the entire email) to third parties who are not on the sender's addressee list and/or to prevent the selected recipient from printing the indicated or selected text (and/or the entire email). Other text control or management functions may also be included on the dissemination menu. Additionally, the text control options available (503, 505, 507, 509) may or may not be mutually exclusive. For example, it may be desirable to mask selected blocks and disable both printing and forwarding for the entire note. The dissemination menu also includes an “insert” function selection 512 by which the sender may insert a predetermined or personal message in place of the user highlighted or selected text in the email message. If the user selects the INSERT function 511 and clicks DONE 513A, another pop-up window 601 will be presented as illustrated by the dynamic 515.

In FIG. 6, a user is enabled to select one or more predetermined or “canned” messages 603, 605 in place of the selected text in the email or the user may input the user's own reasons 607 in block 609. When the user has indicated the substitute text or reason for the blocked text in the email message, the user will click DONE and be returned to the base screen as shown in FIG. 3, and the selected control and/or management functions will be implemented with regard to the email message being composed by the user such that selected ones of the addressees will be limited in what they see and also what they can do (i.e. forward and/or print) with the email after it has been received.

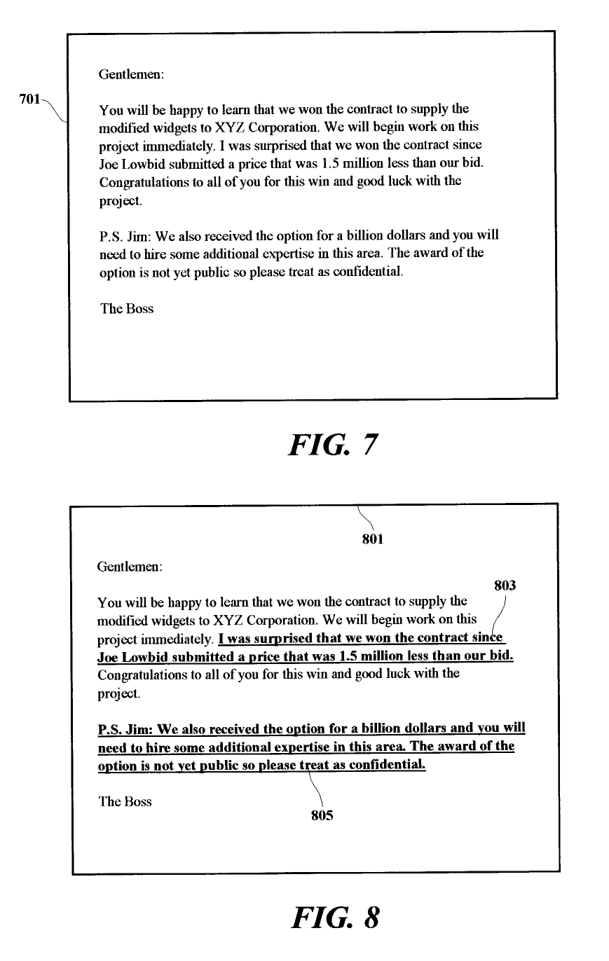

In FIG. 7, an exemplary email is presented in order to help explain an exemplary operation of the present invention. As shown, the email 701 states that a contract has been won and when work will begin. The email also includes some sensitive bid information as well as needed resource information and confidential information. Using the present invention, after composing the illustrated email, the user may highlight the information which needs to be controlled by emboldening and underscoring the affected text 803 and 805 of the email as illustrated in FIG. 8. For example, in one pass through the process, the user may only highlight the first “bid” information 803, then select all recipients other that those pricing personnel concerned with the bid information, then select to omit the bid information from the emails to all but concerned pricing people. In another pass, the user may highlight the resource information 805 and select all addressees other than the Vice President of Human Resources, then select to substitute “Proprietary Information Omitted” (605 FIG. 6) before sending the email. In that case, only the email to the Vice President of Human Resources would contain the resource information 805 and the emails to all of the other addressees would show a blocked section with the message “Proprietary Information Omitted”.

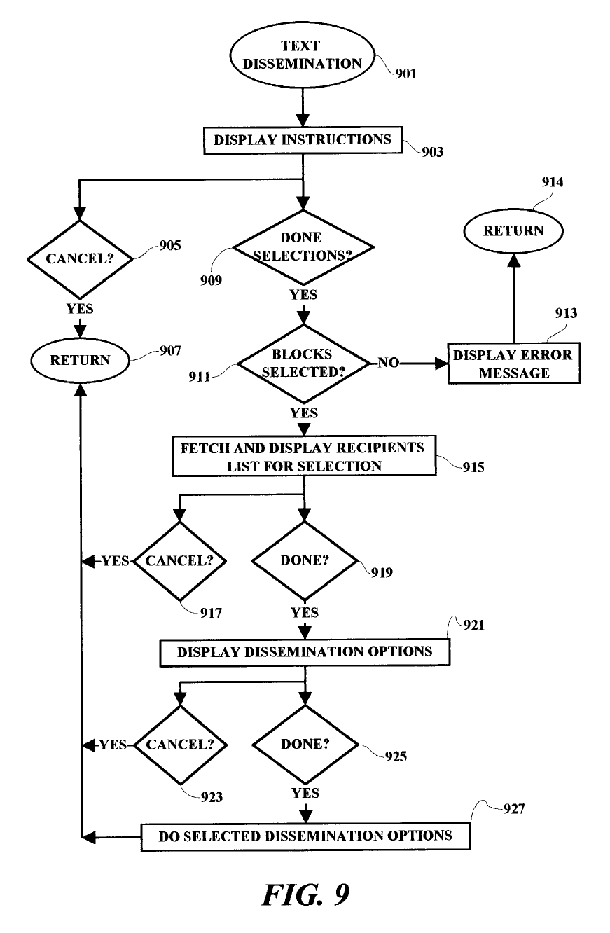

As shown in the flow chart beginning with FIG. 9, the text dissemination process 901 initially displays the instructions 903 as shown, for example, in screen 401. At that point a user may choose to cancel 905 and return 907 to the base email page as shown in FIG. 3. If the user continues with the dissemination function, after the user has made selections and clicked on DONE 909, a check is made 911 to insure that text selections have been properly made by the user. If not, an error message is displayed 913 and/or the process may return 914 to the base email page 301. If text blocks were appropriately selected 911, then the recipients list is fetched and displayed 915 for the user to make selections. Again, at this point, the user may cancel 917 and return to the base page 907 or continue with the dissemination processing. After the user has selected the recipients whose email is to be modified 919, the dissemination options (FIG. 5) are presented 921 from which the user may select as hereinbefore discussed in connection with FIG. 5 and FIG. 6. Again at this point the user may cancel 923 and return or continue and implement the changes made by the user by clicking DONE 925 at which time the selected dissemination options will be implemented 927 and the user is then ready to send the email or make further selections with regard to other text and/or recipients.

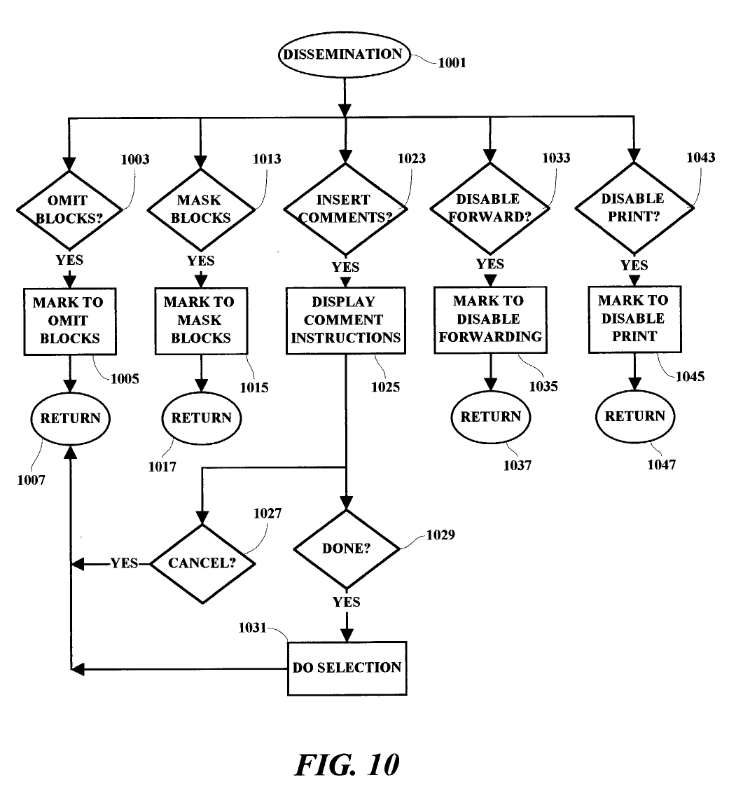

The implementation of the dissemination process 1001 selections is illustrated in FIG. 10 in which the selections made by the user are detected 1003, 1013, 1023, 1033 and 1043 and executed 1005, 1015, 1025, 1035 and 1045, respectively. When the user selects to insert comments 1023 for selected text, the comment instructions (FIG. 6) are displayed 1025. The user may then cancel 1027 and return 1007 or make appropriate selections from the comment instructions. After selections have been made 1029 the selections are implemented 1031 with regard to the subject email and the process returns to the base email page.

Another method for implementation of this invention would be to substitute the “omitted text” indicia for all recipients of the email or electronic note, and to provide a specific “permission list” providing the option for authorized users, at their discretion, to read the omitted text. If a single note contained more than one area of omitted or sensitive “hot” text, each incident of hot text would carry its own individual permission list, such that an authorized viewer of “hot text area 1” would not necessarily be authorized to view “hot text area 2”. Further, it would be permissible to specify an authorized hot text viewer, even if that individual were not a recipient of the current note. This provides the flexibility of sending the same note with different mail options simply by forwarding the completed note or email to an individual and specifying the new mail options in the forwarded note.

As an example, when a technical consultant working on a project receives a note or email with hot text omitted for a stated reason (e.g. Pricing data is not relevant to the current discussion), the technical consultant recipient can make the choice not to spend time reading financial data, which is not of importance to the role of the recipient in the project. If, on the other hand, the reason for omitted text was because it was “technical in nature and of limited interest to the general audience”, then the technical consultant would most certainly want to open and read the “hot text” technical portion of the note or email.

In another example, the selected text is simply removed from the email or note in the selected recipients notes without an indication that any text had been omitted. Optionally, the sensitive selected text would remain in the binary of the note, in an encrypted form. The presence of this text is not obvious to the reader, and using existing techniques, it would not be easily decoded by the reader. Preserving the selected sensitive text in the binary form of the note may provide certain record-keeping advantages, and is considered as optional.

Use of this invention would provide the ability to write a single note to a very wide audience, yet also to limit visibility of sensitive text to only those who need to see it. In one example, the functional flow of this invention for outbound messages is as follows:

01. User selects the function to send a new note using the standard method employed by his software;

02. User writes the note, again using standard methods for selecting audience, priority, return receipts, etc.;

03. User defines sensitive text for inclusion as hot text;

04. User selects text area for conversion to “hot text” with mouse drag or other similar method;

05. User clicks mouse on hot text button which is part of his toolbar, and hot text in the note is highlighted;

06. A pop up box opens and prompts user for hot text reason code and description;

07. User selects a standard reason code, or enters the editor to specify a reason;

08. After selection of reason code, user is prompted for the list of authorized individuals to read the sensitive “hot” text (a deny list could be used, however, this would be less secure, because a note may be forwarded to other individuals who should not see the hot text, but are not included in the deny list);

09. User selects “hot text authorized” individuals with standard tools for selecting note recipients;

10. User exits hot text tool, and highlighted text in the note is replaced with the “reason code statement”;

11. User mails the note using send button, or other standard method.

For “inbound” messages, the following functional flow may be implemented:

01. User receives email and opens to read;

02. User sees the (embedded message) indicating that sensitive or “hot” text has been omitted from the note, (except in the case of stealth text where there is no indication);

03. User places cursor, or mouse, in the hot text message box “[ ]”, then clicks a “hot text” button on the toolbar, (except in the case of stealth text);

04. Pop-up box containing hot text is displayed for user (this box is read only and can not be altered in any way by the reader);

05. User closes pop-up box and continues reading the note

-or-

06. If the user is not authorized to view the hot text, a message box appears denying access;

07. Reader then closes the box and returns to the note

-or-

08. An additional option is provided in the pop-up box for the user to request access to the hot text. This would automatically generate a standard message, via note system, to the originator of the hot text, with the option of providing a reason for the request to view the hot text. The originator, in turn, could choose from several options provided through buttons embedded in this standard note;

09. Ignore request and close note;

10. Deny access (again a standard note would be generated to the requester, with the option of providing a reason);

11. Grant access (again a standard note would be generated, with the option of providing a reason). Choosing “grant” would also update the “permission list” for this specific area of hot text, providing immediate access of the hot text to the requestor;

12. User reads remainder of note including authorized hot text, (if so authorized);

13. User could then process the note in the same manner as any other note; save, close, reply, forward, etc.

In any of the exemplary implementation methods described above, the “hot text” or “stealth text” system would include a “signature function”, documenting within the altered note, the person who created the hot/stealth text, date and time the note was altered, reason code for the alteration, and the individuals permitted access to the hot text. This metadata would be maintained in a special table, or other software entity as a part of the mail database, and would be indexed to each copy of the note mailed out through a note identification number. This could take the form of standard CRCs (cyclic redundancy checks), hashes, or checksums, which validate the authenticity of the sender, regardless of whether or not it contains the hot text. Additionally, the originator of the note would be a mandatory recipient of any “hot text” altered versions of the note, and would always be authorized to review the hot text.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other memory device, from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing content in an electronic communication addressed from a user to a plurality of recipients, said method comprising:
displaying a text message on a display device;
enabling said user to designate a selected portion of said text message for selective processing to provide a modified text message;
enabling said user to designate one or more selected recipients to receive said modified text message; and
sending said electronic communication to said recipients whereby said selected recipients are enabled to reproduce only said modified text message and others of said recipients are enabled to reproduce an unmodified version of said text message.

2. The method as set forth in claim 1 wherein said modified text message includes indicia to indicate that said selected portion has been modified.

3. The method as set forth in claim 1 wherein said modified text message includes no indicia to indicate that said selected portion has been modified.

4. The method as set forth in claim 1 wherein said user is enabled to designate one or more selected recipients by selecting from a listing of said recipients through a user input device.

5. The method as set forth in claim 1 wherein said user is further enabled to designate more than one selected portion of said text message for selective processing.

6. The method as set forth in claim 1 wherein said selective processing includes a plurality of different processing functions, said method further including enabling said user to select one or more of said plurality of different processing functions for association with each of said selected recipients.

7. The method as set forth in claim 6 and further including:
displaying a listing of said different processing functions; and
enabling said user to designate one or more of said different processing functions through a user input device.

8. The method as set forth in claim 7 wherein said different processing functions include deleting said selected portion of said text message from said modified text message.

9. The method as set forth in claim 8 and further including substituting an inserted specified reason for said deletion of said selected portion.

10. The method as set forth in claim 9 wherein said specified reason is input by said user.

11. The method as set forth in claim 10 wherein said specified reason is keyed-in by a user through a user input device.

12. The method as set forth in claim 10 wherein said specified reason is selected by a user from a listing of predetermined reasons displayed to said user.

13. The method as set forth in claim 7 wherein said different processing functions include masking said selected portion of said text message to render said selected portion unreadable by said selected recipient.

14. The method as set forth in claim 7 wherein said different processing functions include disabling printing of said selected portion by said selected recipient.

15. The method as set forth in claim 7 wherein said different processing functions include disabling printing of said modified text message by said selected recipient.

16. The method as set forth in claim 7 wherein said different processing functions include disabling forwarding of said electronic communication from said selected recipient to a third party.

17. The method as set forth in claim 1 and further including:
creating a record separate from said electronic communication, said record identifying said user and associating said selected portions with corresponding ones of said selected recipients; and
storing said record in a storage device.

18. The method as set forth in claim 17 and further including enabling access to said record by only predetermined entities.

19. A storage medium including machine readable coded indicia, said storage medium being selectively coupled to a reading device, said reading device being selectively coupled to processing circuitry within a computer system, said reading device being selectively operable to read said machine readable coded indicia and provide program signals representative thereof, said program signals being effective to enable processing content of an electronic communication addressed from a user to a plurality of recipients, said program signals being selectively operable to accomplish the steps of:
displaying a text message on a display device;
enabling said user to designate a selected portion of said text message for selective processing to provide a modified text message;
enabling said user to designate one or more selected recipients to receive said modified text message; and
sending said electronic communication to said recipients whereby said selected recipients are enabled to reproduce only said modified text message and others of said recipients are enabled to reproduce an unmodified version of said text message.

20. A computer system comprising:
a system bus selectively connectable to a electronic communication network;
a CPU device connected to said system bus;
a memory device connected to said system bus;
a user input device connected to said system bus; and
a display device connected to said system bus, said computer system being selectively operable for processing content of an electronic communication addressed from a user to a plurality of recipients, said computer system being further selectively operable to accomplish the steps of:
displaying a text message on said display device;
enabling said user to designate, through said user input device, a selected portion of said text message for selective processing to provide a modified text message;
enabling said user, through said user input device, to designate one or more selected recipients to receive said modified text message; and
sending said electronic communication to said recipients whereby said selected recipients are enabled to reproduce only said modified text message and others of said recipients are enabled to reproduce an unmodified version of said text message.
